(19) United States
(12) Patent Application Publication
(10) Pub. No.: US 2025/0135448 A1
(43) Pub. Date: May 1, 2025

(54) CATALYST SCRUBBER APPARATUS

(71) Applicant: SAMSUNG ELECTRONICS CO., LTD., SUWON-SI (KR)

(72) Inventors: Jinyoung Lee, Suwon-si (KR); Hyunsik Kim, Suwon-si (KR); Jeongmo Yang, Seoul (KR); Kyeongtae Lim, Seoul (KR); Taewon Seo, Seoul (KR); Sunghyup Kim, Suwon-si (KR); Sangyoon Soh, Suwon-si (KR)

(73) Assignee: IUCF-HYU (INDUSTRY-UNIVERSITY COOPERATION FOUNDATION HANYANG UNIVERSITY), Seoul (KR)

(21) Appl. No.: 18/884,691

(22) Filed: Sep. 13, 2024

(30) Foreign Application Priority Data
Oct. 30, 2023 (KR) 10-2023-0147119

(51) Int. Cl. B01J 38/12; B01D 53/88

(52) U.S. Cl. CPC B01J 38/12; B01D 53/885

(57) ABSTRACT

A catalyst scrubber apparatus includes a housing having an internal space; a catalyst carrier disposed in the internal space of the housing; and a plurality of nozzles installed in the housing and disposed above the catalyst carrier, wherein at least two of the plurality of nozzles are configured to receive and spray fluid therethrough, the at least two of the plurality of nozzles are shaped and dimensioned to diffuse the fluid sprayed into the internal space of the housing.

### CROSS-REFERENCE TO RELATED APPLICATION(S)

This application claims benefit of priority under 35 U.S.C. § 119 to Korean Patent Application No. 10-2023-0147119 filed, on Oct. 30, 2023 in the Korean Intellectual Property Office, the disclosure of which is incorporated by reference herein in its entirety.

### 1. TECHNICAL FIELD

Embodiments of the present inventive concept relates to a catalyst scrubber apparatus.

### 2. DISCUSSION OF THE RELATED ART

Catalyst scrubber apparatuses have been used in scrubber equipment to process chemical gases remaining after use in a semiconductor manufacturing process. Unlike existing facilities using combustion reactions, catalyst scrubber apparatuses use a reaction in which a specific chemical gas is solidified by a specific catalyst.

Thus, as chemical gases are solidified, generated powder blocks in each hole of a catalyst carrier, so it is necessary to periodically inject high-pressure air to remove the powder.

However, removing powder by spraying high-pressure air has low powder removal efficiency.

### SUMMARY

According to an aspect of the present inventive concept, a catalyst scrubber apparatus catalyst scrubber apparatus includes a housing having an internal space; a catalyst carrier disposed in the internal space of the housing; and a plurality of nozzles installed in the housing and disposed above the catalyst carrier, wherein at least two of the plurality of nozzles are configured to receive and spray fluid therethrough, the at least two of the plurality of nozzles are shaped and dimensioned to diffuse the fluid sprayed into the internal space of the housing.

According to an aspect of the present inventive concept, a catalyst scrubber apparatus includes a housing having an internal space; a catalyst carrier disposed in the internal space of the housing; and at least two nozzles installed in the housing and disposed above the catalyst carrier, wherein the nozzle has an inclined surface on an internal surface.

According to an aspect of the present inventive concept, a catalyst scrubber apparatus includes a housing having an internal space; a catalyst carrier disposed in the internal space of the housing, wherein the catalyst carrier uses a catalyst to solidify a chemical gas; and at least two nozzles installed in the housing and disposed above the catalyst carrier, wherein the nozzle has an inclined surface on an internal surface, and wherein the inclination angle of the inclined surface ranges from about 8° to about 10°

### BRIEF DESCRIPTION OF DRAWINGS

The above and other aspects, features, and advantages of the present inventive concept will be more clearly understood from the following detailed description, taken in conjunction with the accompanying drawings, in which:

FIG. 1 is a schematic diagram illustrating a catalyst scrubber apparatus according to an example embodiment;

FIG. 2 is a cutaway perspective view illustrating a catalyst scrubber apparatus according to an example embodiment;

FIG. 3 is an explanatory diagram illustrating a catalyst scrubber apparatus according to an example embodiment;

FIG. 4 is an explanatory diagram illustrating flow of air sprayed into a catalyst scrubber apparatus according to an example embodiment;

FIG. 5 is an explanatory diagram illustrating pressure of air sprayed into a catalyst carrier of a catalyst scrubber apparatus according to an example embodiment;

FIG. 6 is a schematic diagram illustrating a catalyst scrubber apparatus according to an example embodiment; and

FIG. 7 is an enlarged view illustrating portion A of FIG. 6.

### DETAILED DESCRIPTION OF THE EMBODIMENTS

Hereinafter, example embodiments of the present inventive concept will be described with reference to the accompanying drawings.

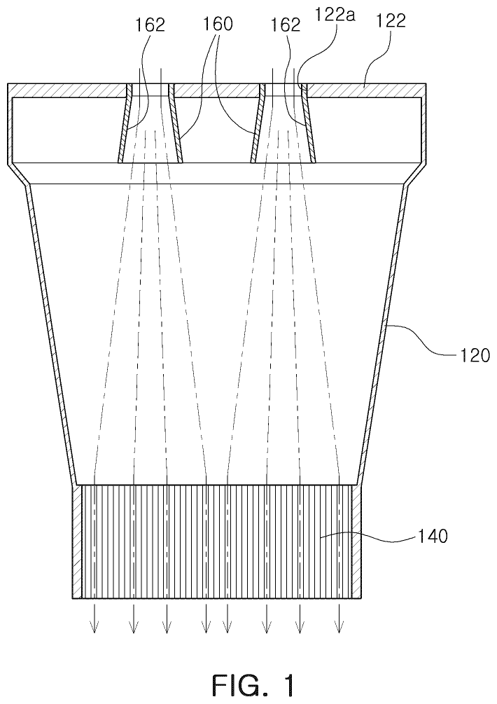

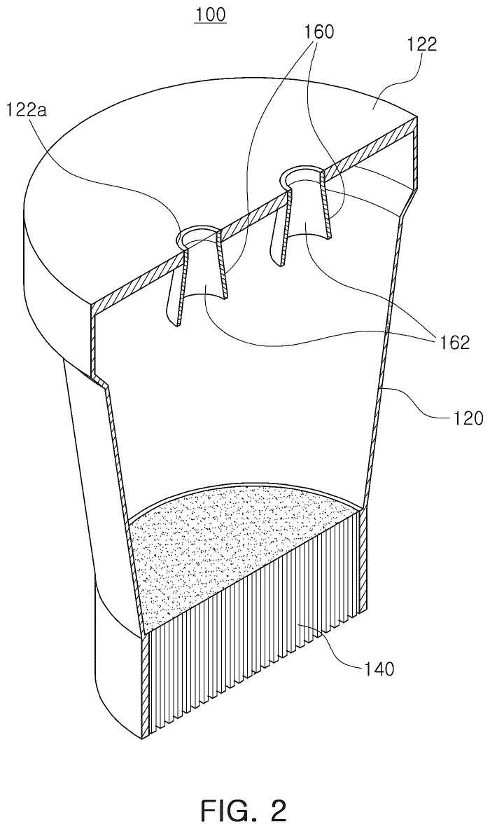

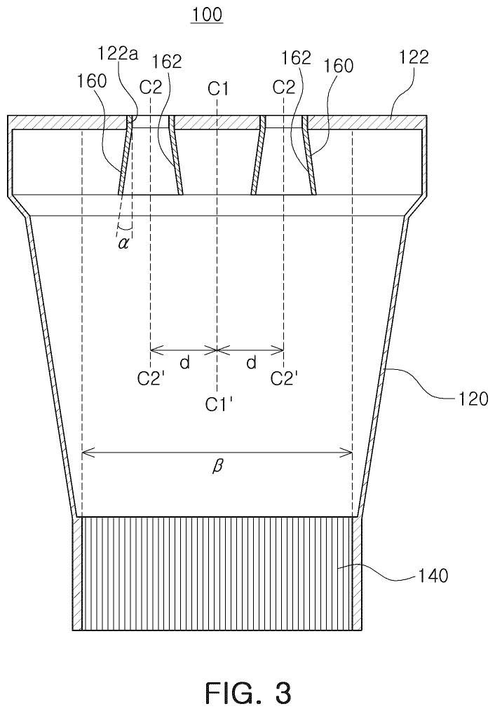

FIG. 1 is a schematic diagram illustrating a catalyst scrubber apparatus according to an example embodiment, FIG. 2 is a cut-away perspective view illustrating a catalyst scrubber apparatus according to an example embodiment, and FIG. 3 is an explanatory diagram illustrating a catalyst scrubber apparatus according to an example embodiment.

Referring to FIGS. 1 to 3, a catalyst scrubber apparatus 100 according to an example embodiment includes a housing 120, a catalyst carrier 140, and a nozzle 160.

The housing 120 has an internal space. As an example, the housing 120 may include a portion in which the catalyst carrier 140 is installed, a portion disposed at an upper end of the portion in which the catalyst carrier 140 is installed, and a portion disposed at a lower end of the portion in which the catalyst carrier 140 is installed.

Meanwhile, a plurality of chemical gas inlets may be provided in a portion disposed at the upper end of the portion in which the catalyst carrier 140 of the housing 120 is installed. As an example, a plurality of chemical gas inlets may be provided on an upper surface of the housing 120, and a plurality of chemical gas inlets may also be provided on side walls of the housing 120. In this manner, a chemical gas introduced through the chemical gas inlets may pass through the catalyst carrier 140 and then be discharged through an outlet disposed in a portion disposed at the lower end in which the catalyst carrier 140 is installed.

In addition, the housing 120 may include an opening hole 122a in which the nozzle 160 is installed on an upper wall of a cylindrical portion 122, and the number of opening holes 122a may correspond to the number of nozzles 160.

The catalyst carrier 140 is disposed in the internal space of the housing 120. The catalyst carrier 140 uses a reaction in which a specific chemical gas is solidified by a specific catalyst. In addition, the catalyst carrier 140 may be a filter-shaped structure providing a flow path for air to flow that increases a contact area between the chemical gas and a catalyst. The catalyst is applied to a surface of the filter-shaped structure so that the chemical gas is solidified, while passing through the filter-shaped structure. The catalyst applied to the surface of the catalyst carrier 140 may be, for example, Carbon Monoxide (Co), ZrO₂—Al₂O₃ or the like. However, without being necessarily limited thereto, the catalyst applied to the surface of the catalyst carrier 140 may vary depending on the type of chemical gas.

The nozzle 160 may be installed in the housing 120 and disposed above the catalyst carrier 140. At least two nozzles may be installed in the housing 120. As an example, the nozzle 160 may have a diffuser shape so that the sprayed fluid, for example, air, may diffuse into the internal space of the housing 120. Meanwhile, a cross-sectional area of the upper end of the nozzle 160 may be smaller than that of the lower end thereof. As an example, two nozzles 160 may be arranged on a straight line passing through the central axis C1-C1′ of the upper wall of the cylindrical portion 122 provided in the housing 120. The two nozzles 160 may be arranged to be symmetrical to the central axis C1-C1′ of the upper wall of the cylindrical portion 122 provided in the housing 120. In addition, the nozzle 160 may have an inclined surface 162 on an internal surface thereof, and an inclination angle α of the inclined surface 162 may range, for example, from about 8° to about 10°. Meanwhile, if the inclination angle α of the inclined surface 162 is less than 8°, backflow may occur in the center of the housing 120 due to reflection of flow of the air sprayed from the nozzle 160 by the internal surface of the housing 120, the upper surface of the catalyst carrier 140 and the influence of a pressure distribution in the internal space of the housing 120. If the inclination angle α of the inclined surface 162 is more than 10°, the powder removal efficiency may be deteriorated due to the influence of an eddy or the like. Thus, the inclination angle α of the inclined surface 162 is, as an example, in the range between about 8° and about 10°.

When a diameter of the catalyst carrier 140 is β, a distance between the central axes C2-C2′ of the two nozzles 160 may range from about 0.4β to about 0.6β. If the distance between the central axes C2-C2′ of the two nozzles 160 less than 0.4β, the air sprayed from the nozzles 160 may overlap, reducing the efficiency of powder removal by air. If the distance between the central axes C2-C2′ of two nozzles 160 is more than 0.6β, the air sprayed from the nozzle 160 may be reflected from the internal surface of the housing 120, causing an eddy or the like, resulting in a decrease in powder removal efficiency. In addition, a distance from the central axis C1-C1′ of the upper wall of the cylindrical portion 122 provided in the housing 120 to the central axis C2-C2′ of the nozzle 160 may be 0.2β to 0.3β. If the distance from the central axis C1-C1′ of the upper wall of the cylindrical portion 122 provided in the housing 120 to the central axis C2-C2′ of the nozzle 160 is less than 0.2β, air sprayed from the nozzle 160 may overlap to deteriorate the efficiency of powder removal by the air. If the distance from the central axis C1-C1′ of the upper wall of the cylindrical portion 122 provided in the housing 120 to the central axis C2-C2′ of the nozzle 160 is more than 0.3β, the air sprayed from the nozzle 160 may be reflected from the internal surface of the housing 120, generating an eddy, and thus, the efficiency of powder removal efficiency may be deteriorated.

Meanwhile, the nozzle 160 may be connected to a tank storing high-pressure air through a supply pipe, and a valve for adjusting the spray amount of air may be installed in the supply pipe. Meanwhile, the air sprayed from the nozzle 160 may periodically push and remove powder generated in the catalyst carrier 140.

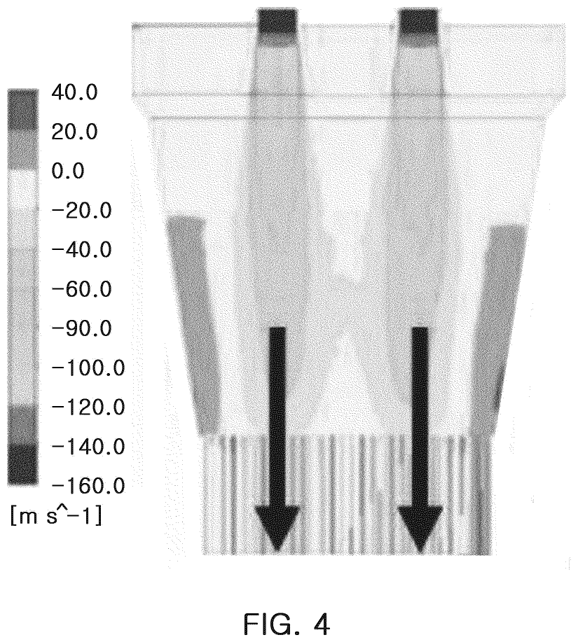

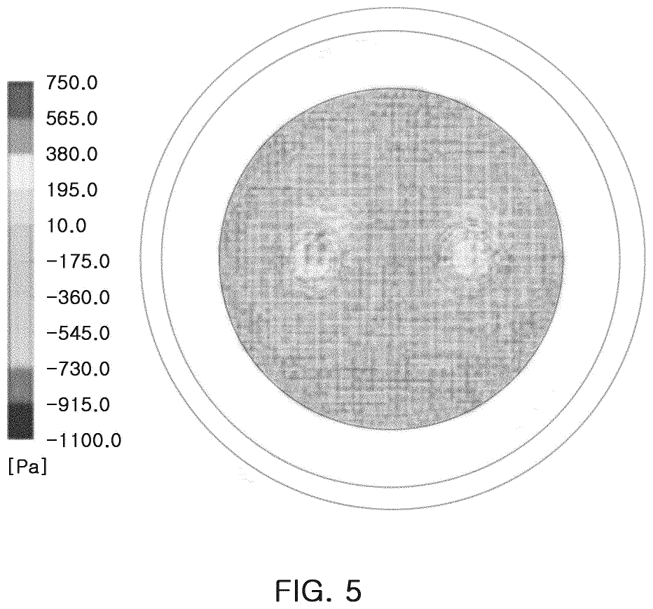

As illustrated in FIG. 4, air sprayed by the nozzle 160 having a diffuser shape may flow and pass through the catalyst carrier 140 without causing backflow. Furthermore, since air is sprayed by the nozzle 160 having a diffuser shape, as illustrated in FIG. 5, the pressure applied to the upper surface of the catalyst carrier 140 is more uniform compared to the varied pressure that impinge upon the upper surface of the catalyst carrier 140 using nozzles that are not shaped and dimensioned to diffuse fluid flow.

As described above, since air is sprayed through the nozzle 160 having the inclined surface 162, a diffusion angle of the high-pressure flow may be expanded. Thus, the mutual overlap between the sprayed air and the flow reflected from the internal surface of the housing 120 is reduced or minimized. Accordingly, a higher efficiency of removing powder accumulated on the catalyst carrier 140 can be achieved.

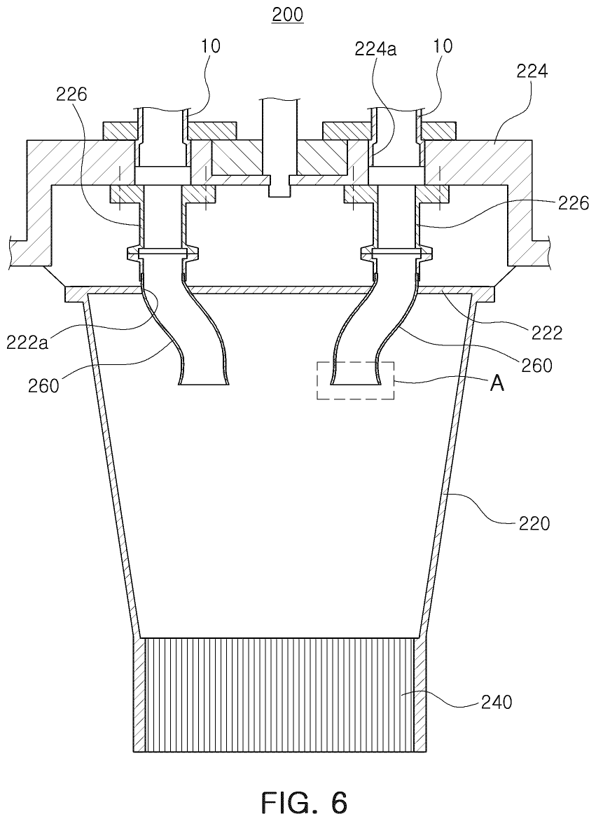

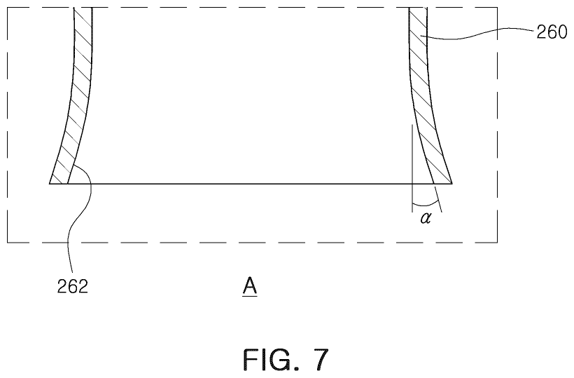

FIG. 6 is a schematic diagram illustrating a catalyst scrubber apparatus according to an example embodiment, and FIG. 7 is an enlarged view illustrating portion A of FIG. 6.

Referring to FIGS. 6 and 7, a catalyst scrubber apparatus 200 according to an example embodiment includes a housing 220, a catalyst carrier 240, and a nozzle 260.

The housing 220 has an internal space. As an example, the housing 220 may include a portion in which the catalyst carrier 240 is installed, a portion disposed at an upper end of the portion in which the catalyst carrier 240 is installed, and a portion disposed at a lower end of the portion in which the catalyst carrier 240 is installed.

Meanwhile, a plurality of chemical gas inlets may be provided in a portion disposed at the upper end of the portion in which the catalyst carrier 240 of the housing 220 is installed. As an example, a plurality of chemical gas inlets may be provided on an upper surface of the housing 220, and a plurality of chemical gas inlets may also be provided on side walls of the housing 220. In this manner, a chemical gas introduced through the chemical gas inlets may pass through the catalyst carrier 240 and then be discharged through an outlet disposed at the lower end in which the catalyst carrier 240 is installed.

In addition, the housing 220 may include an opening hole 222a in which the nozzle 260 is installed on an upper wall of the housing 220. The number of opening holes 222a may correspond to the number of nozzles 260.

The housing 220 may include a cover member 224 on which a connecting member 226 connected to the nozzle 260 is installed. As an example, a supply pipe 10 through which air supplied to the nozzle 260 flows may be installed in the cover member 224, and the supply pipe 10 may include an installation hole 224a of the cover member 224. In addition, the connecting member 226 connected to the nozzle 260 may be installed on the cover member 224. The supply pipe 10 may be connected to a tank in which high-pressure air is stored, and a valve for adjusting supply of air may be installed in the supply pipe 10.

The catalyst carrier 240 is disposed in the internal space of the housing 220. The catalyst carrier 240 uses a reaction in which a specific chemical gas is solidified by a specific catalyst. In addition, the catalyst carrier 240 may be a filter-shaped structure providing a flow path for air to flow that increases a contact area between the chemical gas and a catalyst. The catalyst is applied to a surface of the filter-shaped structure so that the chemical gas is solidified, while passing through the filter-shaped structure. The catalyst applied to the surface of the catalyst carrier 240 may be, for example, Carbon Monoxide (Co), ZrO₂—Al₂O₃ or the like. However, without being necessarily limited thereto, the catalyst applied to the surface of the catalyst carrier 240 may vary, depending on the type of chemical gas.

The nozzle 260 may be installed in the housing 220 and disposed above the catalyst carrier 240. At least two nozzles may be installed in the housing 220. As an example, the nozzle 260 may have a diffuser shape so that the sprayed fluid, for example, air, may diffuse into the internal space of the housing 220. In addition, as illustrated in FIG. 7, the nozzle 260 may have an inclined surface 262 on an internal surface thereof, and an inclination angle a of the inclined surface 262 may range, for example, from about 8° to about 10°. If the inclination angle α of the inclined surface 262 is less than 8°, backflow may occur in the center of the housing 220 due to reflection of flow of the air sprayed from the nozzle 260 by the internal surface of the housing 220, the upper surface of the catalyst carrier 240 and the influence of a pressure distribution in the internal space of the housing 220. If the inclination angle α of the inclined surface 262 is more than 10°, the powder removal efficiency may be deteriorated due to the influence of an eddy or the like. Thus, the inclination angle α of the inclined surface 262 ranges from, as an example, ranges from about 8° to about 10°.

Meanwhile, an experiment was conducted in which air was sprayed through the nozzle 260 for 1.2 seconds at 95.8-second intervals, while uniformly injecting 35 g per minute into the catalyst scrubber apparatus 200 for 20 minutes. It was confirmed that, under the above conditions, when air was sprayed through a nozzle without the inclined surface 262, the amount of powder remaining inside the catalyst carrier 240 was an average of 14.2 g, and in contrast, when air was sprayed through the nozzle 260 having the inclined surface 262, the amount of powder remaining inside the catalyst carrier 240 was only 4 g on average. In addition, it was confirmed that, when air was injected through the nozzle without the inclined surface 262, powder remained in a circular shape in the center of the catalyst carrier 240 and in a band shape near the center. However, when air was sprayed through the nozzle 260 having the inclined surface 262, there was no region on which powder was concentrated in the catalyst carrier 240. As an operating time of the catalyst scrubber apparatus 200 increases, the difference in the amount of remaining powder becomes larger.

As described above, when air is sprayed through the nozzle 260 having the inclined surface 262, powder removal efficiency may be improved.

While example embodiments have been illustrated and described above, it will be apparent to those skilled in the art that modifications and variations could be made without departing from the scope of the present inventive concept as defined by the appended claims.

What is claimed is:

1. A catalyst scrubber apparatus comprising:
a housing having an internal space;
a catalyst carrier disposed in the internal space of the housing; and
a plurality of nozzles installed in the housing and disposed above the catalyst carrier,
wherein at least two of the plurality of nozzles are configured to receive and spray fluid therethrough, the at least two of the plurality of nozzles are shaped and dimensioned to diffuse the fluid sprayed into the internal space of the housing.

2. The catalyst scrubber apparatus of claim 1, wherein a cross-sectional area of an upper end of each of the at least two nozzles is smaller than a cross-sectional area of a lower end of each of the at least two nozzles.

3. The catalyst scrubber apparatus of claim 2, wherein the nozzle has an inclined surface on an internal surface, and an inclination angle of the inclined surface ranges from about 8° to about 10°.

4. The catalyst scrubber apparatus of claim 1, wherein, when a diameter of the catalyst carrier is β, a distance between central axes of the at least two nozzles ranges from about 0.4β to about 0.6β.

5. The catalyst scrubber apparatus of claim 4, wherein a distance from a central axis of an upper wall of the housing to a central axis of the nozzle ranges from 0.2β to 0.3β.

6. The catalyst scrubber apparatus of claim 5, wherein the at least two nozzles are symmetrical to the central axis of the upper wall of the housing.

7. The catalyst scrubber apparatus of claim 4, wherein at least two of the nozzles are arranged along a straight line passing through a central axis of an upper wall of the housing.

8. The catalyst scrubber apparatus of claim 1, wherein the internal space of the housing disposed above the catalyst carrier has a funnel shape narrowing down in width from an upper end to a lower end.

9. The catalyst scrubber apparatus of claim 1, wherein the at least two nozzles are connected to a connecting member installed on a cover member provided in the housing.

10. The catalyst scrubber apparatus of claim 9, wherein a supply pipe is installed in the cover member to supply air to at least two of the two nozzles.

11. The catalyst scrubber apparatus of claim 1, wherein at least two of the nozzles have an inclined surface at an end of an internal surface, and an inclination angle of the inclined surface ranges from about 8° to about 10°.

12. The catalyst scrubber apparatus of claim 11, wherein, when a diameter of the catalyst carrier is β, a distance between centers of the ends of at least two of the nozzles range from about 0.4β to about 0.6β.

13. A catalyst scrubber apparatus comprising:
a housing having an internal space;
a catalyst carrier disposed in the internal space of the housing; and
at least two nozzles installed in the housing and disposed above the catalyst carrier,
wherein the nozzle has an inclined surface on an internal surface.

14. The catalyst scrubber apparatus of claim 13, wherein the inclination angle of the inclined surface ranges from about 8° to about 10°.

15. The catalyst scrubber apparatus of claim 13, wherein, when a diameter of the catalyst carrier is β, a distance between central axes of the at least two nozzles ranges from about 0.4β to about 0.6β.

16. The catalyst scrubber apparatus of claim 15, wherein a distance from a central axis of an upper wall of the housing to a central axis of the nozzle ranges from 0.2β to 0.3β.

17. The catalyst scrubber apparatus of claim 13, wherein the at least two nozzles are symmetrical to the central axis of the upper wall of the housing.

18. A catalyst scrubber apparatus comprising:
a housing having an internal space;
a catalyst carrier disposed in the internal space of the housing,
wherein the catalyst carrier uses a catalyst to solidify a chemical gas; and
at least two nozzles installed in the housing and disposed above the catalyst carrier,
wherein the nozzle has an inclined surface on an internal surface, and
wherein the inclination angle of the inclined surface ranges from about 8° to about 10°.

19. The catalyst scrubber apparatus of claim 18, wherein, when a diameter of the catalyst carrier is β, a distance between central axes of the at least two nozzles range from about 0.4β to about 0.6β.

20. The catalyst scrubber apparatus of claim 15, wherein a distance from a central axis of an upper wall of the housing to a central axis of the nozzle ranges from 0.2β to 0.3β.
